(19) United States
(12) Patent Application Publication
(10) Pub. No.: US 2020/0227702 A1
(43) Pub. Date: Jul. 16, 2020

(54) Cover Device for a Battery Housing of a Traction Battery of a Motor Vehicle, Battery Housing, Traction Battery and Motor Vehicle

(71) Applicant: Bayerische Motoren Werke Aktiengesellschaft, Muenchen (DE)

(72) Inventors: Azad DARBANDI, Unterfoehring (DE); Juergen HILDINGER, Hoehenkirchen-Siegertsbrunn (DE); Florian SCHOEWEL, Muenchen (DE)

(21) Appl. No.: 16/829,766

(22) Filed: Mar. 25, 2020

Related U.S. Application Data
(63) Continuation of application No. PCT/EP2018/073968, filed on Sep. 6, 2018.

(30) Foreign Application Priority Data
Oct. 20, 2017 (DE) 10 2017 218 752.2

(51) Int. Cl. H01M 2/10; H01M 2/12

(52) U.S. Cl. CPC H01M 2/1077; H01M 2220/20; H01M 2/12; H01M 2/1094

(57) ABSTRACT

A cover device is provided for a battery housing of a traction battery of a motor vehicle for covering a receptacle chamber of the battery housing provided for receiving at least two battery cells of the traction battery. The cover device has a top side facing a surrounding region and a bottom side facing the receptacle chamber. The bottom side has a first region associated with degassing elements of the battery cells having a first heat resistance against a hot gas flowing out of the degassing elements. The bottom side has a second region having a second heat resistance which is smaller compared to the first heat resistance.

### CROSS REFERENCE TO RELATED APPLICATIONS

This application is a continuation of PCT International Application No. PCT/EP2018/073968, filed Sep. 6, 2018, which claims priority under 35 U.S.C. § 119 from German Patent Application No. 10 2017 218 752.2, filed Oct. 20, 2017, the entire disclosures of which are herein expressly incorporated by reference.

### BACKGROUND AND SUMMARY OF THE INVENTION

The invention relates to a cover device for a battery housing of a traction battery of a motor vehicle for covering a receiving space of the battery housing, which is provided for receiving at least two battery cells of the traction battery, comprising a top side, which faces toward a surroundings region, and a bottom side, which faces toward the receiving space. The invention furthermore relates to a battery housing, to a traction battery and to a motor vehicle.

Traction batteries or high-voltage power stores are provided for electrically drivable motor vehicles, for example electric vehicles or hybrid vehicles. Such motor vehicles commonly have, in the drivetrain, an electric machine or an electric motor for driving the motor vehicle, and also the traction battery, which provides electric power for the electric machine. Such traction batteries commonly comprise a plurality of interconnected battery cells, which are arranged in a receiving space of a battery housing. Here, a situation may arise in which one battery cell thermally overheats, for example owing to short-circuits within the cell, mechanical loading, etc. Such an event of damage to the battery cell in the form of a thermal event is commonly accompanied by hot degassing, in the case of which hot gas generated in the battery cell is conducted out of the battery cell into the receiving space of the battery housing via a degassing element, for example a rupturing membrane. In this regard, DE 10 2011 002 631 A1 discloses a battery cell module with a plurality of battery cells which have in each case one degassing opening, and having a cover which has a gas-receiving space for at least temporarily receiving gas that has escaped from the battery cells.

It is a problem if, as a result of thermal propagation, those battery cells within the battery housing which are adjacent to the damaged battery cell are likewise caused to undergo degassing, and the battery housing is damaged by the heat transported by the hot gas. This can result in fire or flames which can escape from the battery housing. If body parts of the motor vehicle which are adjacent to the battery housing likewise ignite as a result, this can pose a hazard to vehicle occupants.

It is an object of the present invention to provide a solution with which a battery housing for a traction battery of a motor vehicle can be, firstly, particularly safe and damage-resistant, and secondly, particularly inexpensive and of a material-saving design.

This and other objects are achieved by way of a cover device, a battery housing, a traction battery and a motor vehicle, according to the claimed invention.

A cover device according to the invention for a battery housing of a traction battery of a motor vehicle for covering a receiving space of the battery housing, which is provided for receiving at least two battery cells of the traction battery, comprises a top side, which faces toward a surroundings region, and a bottom side, which faces toward the receiving space. The bottom side has a first region which is assigned to degassing elements of the battery cells. This first region has a first heat resistance to a hot gas flowing out of the degassing elements. Furthermore, the bottom side has a second region with a second heat resistance which is lower than the first heat resistance.

The cover device serves for covering, in particular completely covering, the battery housing and thus for closing off the receiving space with respect to the surroundings region. The battery housing may for example be of box-shaped or cuboidal design, wherein the cover device is designed in particular as a plate-like lid. Here, a plurality of battery cells can be arranged in the receiving space. The battery cells may for example be prismatic battery cells which are arranged in rows adjacent to one another and/or in columns one behind the other in the receiving space. Such prismatic battery cells commonly have a cuboidal battery cell housing in which a galvanic element is arranged. The battery cells furthermore have, at their top sides facing toward the cover device, respective degassing elements or ventilation elements via which a hot gas generated in the battery cell in the event of damage can be discharged from the battery cell. For this purpose, above a particular internal pressure within the battery cell, the degassing element is activated, such that the hot gas generated in the battery cell can escape from the battery cell into the receiving space. Such a degassing element may for example be a valve which is open in the activated state, or a rupturing membrane which is broken in the activated state.

To now prevent the battery housing from being destroyed by the hot gas escaping from the battery cells, the cover device has the first region, which is assigned to the degassing elements. This means that the first region is situated in the flow path of the hot gas of the degassing elements and is thus impinged on by the hot gas in the active state of a degassing element. In the activated state of the degassing element, the first region is subject to an action of heat owing to the hot gas. In particular, the first region has, for each degassing element, a subregion which, in a state of the cover device in which it covers the receiving space, is arranged in a flow path of the hot gas of the associated degassing element. Each battery cell is therefore assigned a subregion of the first region, which subregion is situated in the flow path of the hot gas escaping from the degassing element. The first region therefore does not need to be of coherent form, but rather may have subregions which are spaced apart from one another.

Here, the first region has the first heat resistance and is therefore resistant to the hot gas at least over a predetermined period of time. In other words, the first region, if it is impinged on by the hot gas, remains undestroyed at least over the predetermined period of time of the action of heat owing to the first heat resistance. In this way, the battery housing is in a functional state despite an action of heat on the cover device. The period of time is for example selected such that a driver of the motor vehicle can park the motor vehicle and disembark within the period of time. For this purpose, it is for example possible, when a temperature exceeding a particular threshold value is detected within the battery housing, for a warning signal to be output to the driver, which warning signal instructs the driver to park the motor vehicle. By means of the first region of the cover device, the battery housing is of particularly safe design and remains functional or undamaged even in the event of damage to the battery cells. In this way, it is advantageously possible to prevent vehicle occupants from being put at risk by an overheating traction battery.

The second region, which is situated substantially outside the flow path, has the second heat resistance, which is lower than the first heat resistance. This means that the period of time over which the second region impinged on by the hot gas remains undestroyed is shorter than the predetermined time period. The first region is thus thermally reinforced in relation to the second region. In other words, the first region can be subjected to higher thermal load than the second region. The second region is in particular formed adjacent to the first region, and may for example divide or separate at least two subregions of the first region from one another. Here, the invention is based on the realization that the second region, which is not situated in the flow path of the hot gas, is not subjected to an action of heat, or is subject to a lesser action of heat than the first region, even in the event of damage to the battery cell. Therefore, the provision of a first heat resistance, which is commonly associated with costs and additional material, is not necessary in the second region. In this way, the cover device and thus the battery housing can be of particularly inexpensive, material-saving and weight-saving design.

Preferably, an area of the first region is smaller than an area of the second region. This can be provided in particular for battery housings which are designed for receiving prismatic battery cells with particular minimum dimensions. The prismatic battery cells commonly have the shape of a shallow cuboid which has a height and width greater than the depth. In particular, above a particular minimum width of the prismatic battery cells, a spacing between the degassing elements of two battery cells which are adjacent in a width direction (in one row) is of such a size that a major part of the bottom side of the cover device between the two degassing elements does not lie in the flow path of the hot gas. This region of the bottom side can be formed as the inexpensive and material-saving second region.

The first region on the bottom side of the cover device preferably has a position owing to which, in a state of the cover device in which it covers the receiving space, the first region is arranged above the associated degassing elements in a vertical direction and so as to fully overlap the associated degassing elements. In particular, the respective subregions of the first region on the bottom side of the cover device have a position owing to which, in the state of the cover device in which it covers the receiving space, the partial regions are arranged above the associated degassing elements in a vertical direction and so as to fully overlap the associated degassing elements. The degassing elements are in particular arranged on top sides, which face toward the cover device, of the battery cells. When the battery cells are arranged in the receiving space and the battery housing has been closed by means of the cover device, the partial regions of the first region are situated in alignment above the degassing elements. By virtue of the fact that the flow direction of the hot gas, that is to say an extent direction of the flow path, corresponds in particular to the vertical direction, it can be ensured that predominantly the first region is impinged on by the hot gas escaping from the battery cells.

It is preferable if an area of subregions, assigned to the respective battery cells, of the first region is larger than a surface, facing toward the bottom side of the cover device, of the respective degassing elements. In particular, the area of the subregions is at least twice as large as the surface of the degassing elements. The surface of the degassing elements corresponds in particular to an area of a gas outlet opening of the degassing element. Owing to the enlarged area of the associated subregion in relation to the degassing element, the battery housing can be of particularly safe design, and remains functional at least over the predetermined period of time even in the event of a propagation of heat.

In one refinement of the invention, the first region has at least one strip-shaped region which corresponds with the degassing elements of at least two battery cells which are arranged adjacent to one another along an extent direction of the strip-shaped region. The strip-shaped region may for example be formed by at least two mutually adjacent subregions of the first region. This embodiment is particularly advantageous if a plurality of prismatic battery cells is arranged in the receiving space of the battery housing in one column (in the depth direction of the receiving space). In the depth direction, which corresponds to the extent direction, a plurality of battery cells can be stacked or arranged one behind the other owing to the shallow construction of the prismatic battery cells. The top sides of the battery cells, and thus the degassing elements, are in this case situated in particular at one level.

Owing to the small depth of the prismatic cells, the degassing elements have a small spacing to one another in the extent direction. Owing to this small spacing of the degassing elements, the associated subregions of the first region also have a small spacing to one another, and can thus be combined to form the strip-shaped region. The strip-shaped region extends in particular over the entire dimension, oriented along the depth direction, of the cover device as far as an edge of the cover device. Here, multiple columns with battery cells can be arranged adjacent to one another in the receiving space, wherein each column is assigned a strip-shaped region of the first region. The second region can then be formed adjacent to the strip-shaped regions. The cover device thus has strip-shaped regions of the first and of the second regions in alternation in the width direction of the receiving space.

In one embodiment of the invention, the bottom side of the cover device has a heat protection coating, in particular a ceramic, only in the first region for the purposes of providing the first heat resistance. The second region is in particular formed without a heat protection coating. In this embodiment, the cover device has, in regions, multiple layers situated one above the other in the vertical direction. The cover device has a first layer, the top side of which forms the top side of the cover device. The first layer may for example have aluminum or steel. A bottom side of the first layer in this case forms the second region. A second layer in the form of the heat protection coating, which is formed from a fire-resistant material, is arranged in the first region adjacent to the first layer. Such a heat protection coating arranged in regions may be provided particularly easily for example by masking the bottom side of the first layer in the second region and applying the heat protection coating in the unmasked first region.

Provision may also be made whereby the cover device is of single-layer form and has, on the bottom side, a height profile by means of which the cover device has a first layer thickness in the first region for the purposes of providing the first heat resistance and has a second layer thickness, which is smaller than the first layer thickness, in the second region for the purposes of providing the second heat resistance. In this embodiment, the cover device is in particular formed in one piece from one material, for example aluminum or steel. To provide the first heat resistance, the layer thickness of the cover device, that is to say a spacing between the top side and the bottom side of the cover device, is increased in the first region in relation to the second region. The height profile thus has a course which is in particular in the shape of a rectangular function. The top side has in particular a planar, stepless surface. Such a cover device can be produced particularly easily and inexpensively.

The invention furthermore relates to a battery housing for a traction battery of a motor vehicle, having a housing lower part, which forms a receiving space, and having a cover device according to the invention or an embodiment thereof. The battery housing is in particular of box-shaped form. The housing lower part has a housing base, which is situated opposite the cover device, and a side wall, which encircles the housing base.

The invention furthermore includes a traction battery for a motor vehicle, comprising at least two battery cells and a battery housing according to the invention. The traction battery is designed for providing electric power for an electric machine of the motor vehicle. The battery cells are in particular prismatic battery cells which have the degassing elements. In the arranged state of the battery cells in the receiving space, the degassing elements face toward the bottom side of the cover device.

A motor vehicle according to the invention comprises a traction battery according to the invention. The motor vehicle is designed in particular as an electric vehicle or hybrid vehicle.

The embodiments presented with regard to the cover device according to the invention, and the advantages thereof, apply correspondingly to the battery housing according to the invention, to the traction battery according to the invention and to the motor vehicle according to the invention.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic perspective view of a traction battery having battery cells and a battery housing.

FIG. 2 is a schematic perspective view of parts of the traction battery with an embodiment of a cover device according to the invention.

FIG. 3 is a schematic cross-sectional view of a traction battery with a further embodiment of a cover device according to the invention.

In the figures, identical and functionally identical elements are denoted by the same reference designations.

### DETAILED DESCRIPTION OF THE DRAWINGS

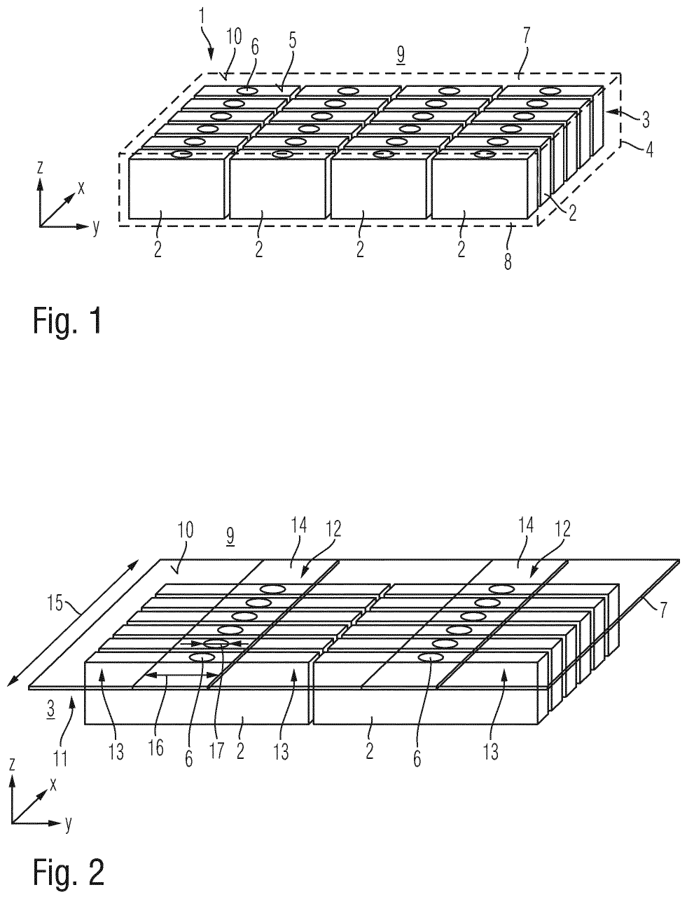

FIG. 1 shows a traction battery 1 for an electrically drivable motor vehicle (not illustrated here). The traction battery 1 is designed for providing electric power for an electric machine or an electric motor of the motor vehicle. For this purpose, the traction battery 1 has a plurality of interconnected battery cells 2, which are arranged in a receiving space 3 of a battery housing 4. The battery housing 4 is illustrated here as being transparent. The battery cells 2 are in this case designed as plate-shaped prismatic battery cells 2 which are in this case arranged in columns one behind the other (in a depth direction or x direction) and in rows adjacent to one another (in a width direction or y direction).

Each of the battery cells 2 has, on its top side 5, a degassing element 6 which is designed to discharge hot gas from the associated battery cell 2 into the receiving space 3. A flow path of the hot gas escaping from the degassing elements 6 is in this case oriented substantially in a vertical direction (z direction). Such hot gas commonly forms in an event of damage in the form of a thermal event in the battery cell 2, for example in the event of a short circuit, mechanical loading or the like. The degassing element 6 may for example be a valve or a membrane, by means of which the hot gas can escape when a particular cell internal pressure is exceeded.

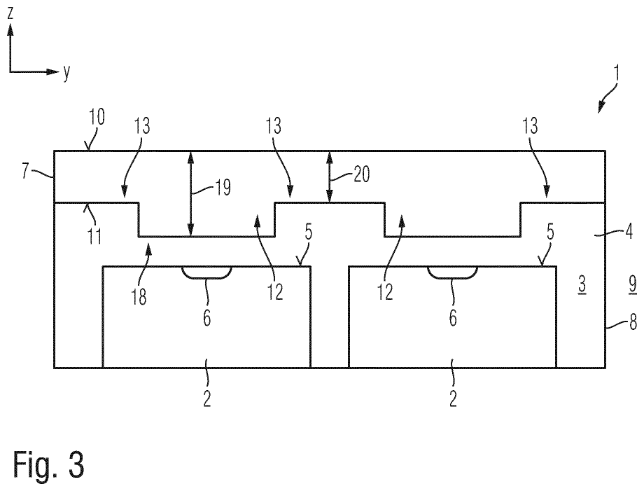

The battery housing 4 has a cover device 7, which closes off the receiving space 3 in an upward direction, and a housing lower part 8. By means of the housing lower part 8 and the cover device 7, the receiving space 3 is closed off with respect to a surroundings region 9. The cover device 7 may for example have a plate composed of aluminum or sheet steel. The cover device 7 has a top side 10, facing toward the surroundings region 9, and a bottom side 11, facing toward the receiving space 3 (see FIG. 2 and FIG. 3). The bottom side 11 of the cover device 3 is designed to be fire-resistant or heat-resistant for the hot gas in regions. For this purpose, the bottom side 11 of the cover device 7, which is shown in transparent form in FIG. 2 for illustrative purposes, has a first region 12 with a first heat resistance and a second region 13 with a second heat resistance which is lower than the first heat resistance. The first region 12 is assigned to the degassing elements 6 and is situated in a flow path of the hot gas of the degassing elements 6. For this purpose, the first region 12 is arranged above the degassing elements 6 in the vertical direction (z direction).

The second region 13 is formed adjacent to the first region 12. The first region 12 with the first heat resistance in this case has a greater resistance to the heat transported by the hot gas than the second region 13. Since the second region 13 is not situated in the flow path of the hot gas and is therefore not impinged on, or impinged on to a lesser extent, by the heat transported by the hot gas, the second region 13 has the second heat resistance, which is lower than the first heat resistance. The first region 12 in this case has two strip-shaped regions 14 which extend in the x direction over an entire depth 15 of the cover device 7. The second region 13 is formed adjacent to the strip-shaped regions 14, that is to say adjacent to the first region 12. Here, a width 16 of the strip-shaped region 14 is greater than, in particular twice as great as, a diameter 17 of the degassing elements 6. It is thus possible to prevent the cover device 7 from being damaged if the heat propagates on the bottom side 11 of the cover device 7.

In order to provide the first heat resistance of the first region 12, the bottom side 11 of the cover device 7 may be coated in regions with a heat protection coating. The heat protection coating has in particular a fire-resistant material, for example a ceramic. For this purpose, it is for example possible for the heat protection coating to be arranged in the first region 12 on the bottom side 11 of the plate of the cover device 7, whereas, by contrast, no heat protection coating is arranged in the second region 13. The second region 13 is thus formed by the plate itself.

Provision may also be made whereby, as shown in the cross-sectional view of the traction battery 1 in FIG. 3, the cover device 7 is of single-layer form and has, on the bottom side 11, a height profile 18 owing to which the cover device 7 has a first layer thickness 19 in the first region 12 and has a second layer thickness 20, which is smaller than the first layer thickness 17, in the second region 13. The first heat resistance is provided or realized by the first layer thickness 17, and the second heat resistance is provided or realized by the second layer thickness 20.

The cover device 7 thus has a partially non-fire-resistant region, specifically the second region 13, and a fire-resistant region, specifically the first region 12, which is formed by in situ reinforcement of the cover device 7 above the degassing elements 6. By means of this cover device 7, a particularly safe and at the same time inexpensive and material-saving battery housing 4 can be provided.

### LIST OF REFERENCE DESIGNATIONS

1 Traction battery
2 Battery cell
3 Receiving space
4 Battery housing
5 Top side
6 Degassing element
7 Cover device
8 Housing lower part
9 Surroundings region
10 Top side
11 Bottom side
12 First region
13 Second region
14 Strip-shaped region
15 Depth of the cover device
16 Width of the strip-shaped region
17 Diameter
18 Height profile
19 First layer thickness
29 Second layer thickness

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A cover device for a battery housing of a traction battery of a motor vehicle for covering a receiving space of the battery housing, which receiving space is provided for receiving at least two battery cells of the traction battery, comprising:
a top side, which faces toward a surroundings region; and
a bottom side, which faces toward the receiving space, wherein
the bottom side has a first region which is assigned to degassing elements of the battery cells and which has a first heat resistance to a hot gas flowing out of the degassing elements, and
the bottom side has a second region with a second heat resistance which is lower than the first heat resistance.

2. The cover device according to claim 1, wherein
an area of the first region is configured to be smaller than an area of the second region.

3. The cover device according to claim 1, wherein
the first region on the bottom side of the cover device has a position owing to which, in a state of the cover device in which the receiving space is covered, the first region is arranged above the degassing elements in a vertical direction so as to fully overlap the degassing elements.

4. The cover device according to claim 3, wherein
an area of a subregion, assigned to the respective battery cell, of the first region is larger than a surface, facing toward the bottom side of the cover device, of the degassing element of the respective battery cell.

5. The cover device according to claim 1, wherein
the first region has at least one strip-shaped region which corresponds with the degassing elements of at least two battery cells which are arranged adjacent to one another along an extent direction of the strip-shaped region.

6. The cover device according to claim 1, wherein
the bottom side of the cover device has a heat protection coating only in the first region for providing the first heat resistance.

7. The cover device according to claim 6, wherein
the coating is a ceramic.

8. The cover device according to claim 1, wherein
the cover device is of single-layer form and has, on the bottom side, a height profile by which the cover device has a first layer thickness in the first region for providing the first heat resistance and has a second layer thickness, which is smaller than the first layer thickness, in the second region for providing the second heat resistance.

9. A battery housing for a traction battery of a motor vehicle, comprising:
a housing lower part, which forms a receiving space; and
a cover device according to claim 1.

10. A traction battery for a motor vehicle, comprising:
at least two battery cells; and
a battery housing according to claim 9, wherein
the at least two battery cells are arranged within the receiving space of the battery housing.

11. A motor vehicle comprising a traction battery according to claim 10.
